(19) United States
(12) Patent Application Publication
(10) Pub. No.: US 2002/0161934 A1
(43) Pub. Date: Oct. 31, 2002

(54) System and method for communication of data between a host and an administration system

(76) Inventors: Robert E. Johnson, Auburn, CA (US); Tom Milner, Meadow Vista, CA (US)

Correspondence Address: HEWLETT-PACKARD COMPANY, Intellectual Property Administration, P.O. Box 272400, Fort Collins, CO, 80527-2400, US

(21) Appl. No.: 09/845,844

(22) Filed: Apr. 30, 2001

(51) Int. Cl. G06F 9/46

(52) U.S. Cl. 709/330

(57) ABSTRACT

The present invention is directed towards a system and method for the communication of computer data between at least one host and an administration system (preferably, a storage management system). In at least one embodiment, discovery data is gathered by one or more host systems (preferably by an agent residing on each of these host systems) and the structure(s) of such data is(are) defined using a markup language (preferably XML). In at least one embodiment, the data is then transported from the host systems to the storage management system via a remote procedure call (preferably an operating system independent remote procedure call such as Java RMI).

### BACKGROUND

Businesses, as well as other organizations, often own and operate sizeable computer systems. Such sizeable computer systems are sometimes referred to in the art as enterprise environments or enterprise systems. Any portion of an enterprise environment that is monitored and managed as a unit may be referred to as a host system. The contents of a host system may range from a single client device or server device to a plurality of server devices, client devices, peripheral devices, connector devices, and more.

In addition, a host system may include one or more data storage devices or have one or more data storage devices communicatively coupled thereto. The list of storage devices that may be embedded in or communicatively coupled to a host system include hard drives, disk drives, compact disc (CD) drives, high capacity disk drives, JBODs (Just a Bunch Of Disks), tape drives, tape libraries, disk arrays, mid-range disk arrays, high-end disk arrays (e.g., Hewlett Packard SureStore™ Disk Array XP256), stackers, drivers, and warehouses, as well as other data storage devices now known or later developed. Storage devices may be communicatively coupled to a host system through any one of numerous means to include a SCSI (Small Computer System Interface) interface, a fibre channel interface, and a data network interface.

The different host systems, as well as storage-related devices, of an enterprise environment are generally not uniform. In fact, in most circumstances, at least two host systems in an enterprise environment differ in hardware, software, firmware, data structures, associations, process, policies, and/or the like. As an example, different host systems, as well as different elements of a host system, may function under different operating systems (e.g., one system or element may run HP-UX®, while another may run Windows NT®, AIX®, SUN®, Linux, etc.). In addition, the different host systems may have different protocols, different application programming interfaces (APIs) or other interfaces, etc.

To ensure the gathering and processing of information in an efficient and organized manner, enterprise environments often include management or administration systems that oversee the operation of one or more aspects of the host systems. Included in some management/administration systems is a storage management system whose responsibility it is to manage and monitor the operation of the storage devices embedded in or communicatively coupled to the various host systems. In at least one instance, the storage management system includes storage management software running on a designated computer or group of computers included in or communicatively coupled to the enterprise environment.

In order to accomplish its designated tasks, oftentimes the storage management system requires information from the host systems regarding the storage devices that are embedded in or attached thereto.

Previous approaches to facilitate communication of such information between host systems and a storage management system include transporting data in a character format using simple network management protocol (SNMP). One notable disadvantage of this approach is the slow rate at which data is provided to the storage management system by a host system when there is variability in data structures between the host system and the storage management system, which, as mentioned earlier, is a strong possibility. Depending upon the circumstances, certain pieces of data may have to be provided to the storage management system one element at a time. These multiple transfers of data add a significant load to the enterprise environment, particularly the communicating host system and storage management system.

In addition, although this approach may provide improved flexibility compared to, e.g., transferring data in binary format, such an approach still requires significant coordination and development effort when an interface of either the host system or the management system is changed. In addition, significant effort is required to port an SNMP interface to each operating system of an enterprise environment.

Other approaches previously attempted include transporting the data in binary format using Distributed Computing Environment (DCE) or sockets. Although these approaches have a substantial speed advantage compared to the SNMP solution described earlier, the DCE or sockets approaches present substantial coordination difficulties. For instance, in order to have communication between a host and the storage management system under such approaches, the two systems must be perfectly matched with respect to data structures, interfaces, protocols, etc. Therefore, if any changes are made to the interface of either system (e.g., new data elements are added, old elements are removed, etc.), both sides of the host/management system interface must be recompiled and coordinated to ensure that they are synchronized. For businesses that update software on some host systems but not on others, such a solution is impractical unless significant development efforts are expended to make the management system support multiple interfaces, as well as to enable the system to automatically determine which interface to use when communicating with a particular host system. In addition, transporting data in binary format using DCE or sockets requires significant development to support each operating system for the environment.

### SUMMARY OF THE INVENTION

The present invention is directed to a system and method for communication between at least one host and an administration system of a computing environment. In one embodiment, data relating to at least one host system and/or at least one storage-related device embedded in or communicatively coupled thereto is gathered by the host system (e.g., by an agent residing thereon). The structure of said information is defined using a flexible markup language. In a preferred embodiment, this flexible markup language is extensive markup language (XML).

Simultaneous with the formatting of said information or at some point thereafter, this formatted data is provided to a management system. In at least one embodiment, the formatted data is provided via a remote procedure call. Preferably, the remote procedure call is operating system independent (e.g., Java Remote Method Invocation (Java RMI)).

In at least one embodiment, at the management system, the data is provided to an interface of the management system. Preferably, the interface is flexible so as to account for differences between the provided data and the elements or fields of a management system interface.

It should be recognized that one technical advantage of one aspect of at least one embodiment of the present invention is the speed at which such communication may take place (in at least one embodiment, some sixty (60) times faster than previous communication methods). Another notable advantage of embodiments of the present invention is flexibility. For example, in embodiments where the remote procedure call is operating system independent, no new development or recompilation is required to support new operating systems. Moreover, by formatting the data using a flexible markup language (e.g., XML), the present invention is flexible to interface changes.

### BRIEF DESCRIPTION OF THE DRAWING

FIG. 1 depicts an exemplary arrangement of an enterprise environment in accordance with an embodiment of the present invention;

FIG. 2 depicts an exemplary embodiment of an embedded storage configuration;

FIG. 3 depicts an exemplary embodiment of a directly attached storage configuration;

FIG. 4 depicts an exemplary embodiment of a directly attached shared storage configuration;

FIG. 5 depicts an exemplary embodiment of a network attached storage configuration;

FIG. 6 depicts an exemplary embodiment of a storage area network configuration;

FIG. 7 depicts an exemplary embodiment of the actions performed on a quantum of information provided to an embodiment of a storage management system in accordance with the present invention; and

FIG. 8 depicts a block diagram of a computer system which is adapted to use the present invention.

### DETAILED DESCRIPTION

FIG. 1 depicts an exemplary enterprise environment arranged according to an embodiment of the present invention. Included in enterprise environment 100 of FIG. 1 are one or more host systems, illustrated in FIG. 1 as host systems 101-1, 101-2, and 101-n. In the embodiment of FIG. 1, residing on each of host systems 101-1, 101-2, and 101-n are one or more host agents, represented in FIG. 1 as agent(s) 106-1, 106-2, and 106-n. In addition, embedded in or communicatively coupled to each of the one or more host systems are one or more data storage devices, illustrated in FIG. 1 as storage device(s) 102-1, 102-2, and 102-n. In an alternative embodiment, at least one of the host systems of enterprise environment 100 has no storage device(s) embedded in or attached thereto. In addition to being communicatively coupled to storage device(s) 102-1, 102-2, and 102-n, in the embodiment of FIG. 1, host systems 101-1, 101-2, and 101-n are also communicatively coupled to data network 103. In at least some embodiments, storage device(s) 101-1, 101-2, and 101-n are coupled to data network 103 as well (not shown in FIG. 1). In addition to the above systems and devices, storage management system 104 is also communicatively connected to data network 103 in the embodiment of FIG. 1.

Similar to the earlier discussion regarding host systems, host systems 101-1, 101-2, and 101-n may include any number of computers and related devices (including, for example, input and output devices, such as displays, speakers, keyboards, pointing devices, printers, etc). As previously mentioned, in the embodiment of FIG. 1, residing on each of host 20 systems 101-1, 101-2, and 101-n, are host agent(s) 106-1, 106-2, 106-n respectively. A host agent may be implemented as an executable program that exists as a running process or service on a host system of enterprise environment 100 (as is the case with agent(s) 106-1, 106-2, and 106-n of FIG. 1). Furthermore, typically a host agent comprises various components for various tasks. In addition, generally a host system has only one host agent residing thereon. However, a host system may have a plurality of host agents residing on the host system. For instance, for host systems that include a plurality of server devices, each server device may have a host agent residing thereon.

Also similar to earlier discussions, storage device(s) 102-1, 102-2, and 102-n may include any number of numerous known or later developed data storage devices to include hard drives, disk drives, compact disc (CD) drives, high capacity disk drives, JBODs (Just a Bunch Of Disks), tape drives, tape libraries, disk arrays, mid-range disk arrays, high-end disk arrays (e.g., Hewlett Packard SureStore™ Disk Array XP256), stackers, drivers, warehouses, and the like.

Each of the connections shown in FIG. 1 between a host system (e.g., host system 101-1) and a storage device(s) (e.g., storage device(s)102-1) is a simplified block diagram representation of the actual connection(s) that may occur between the host system and the storage device(s). It will be appreciated that the actual arrangement of the connection between the storage device(s) and the host system may take on many forms.

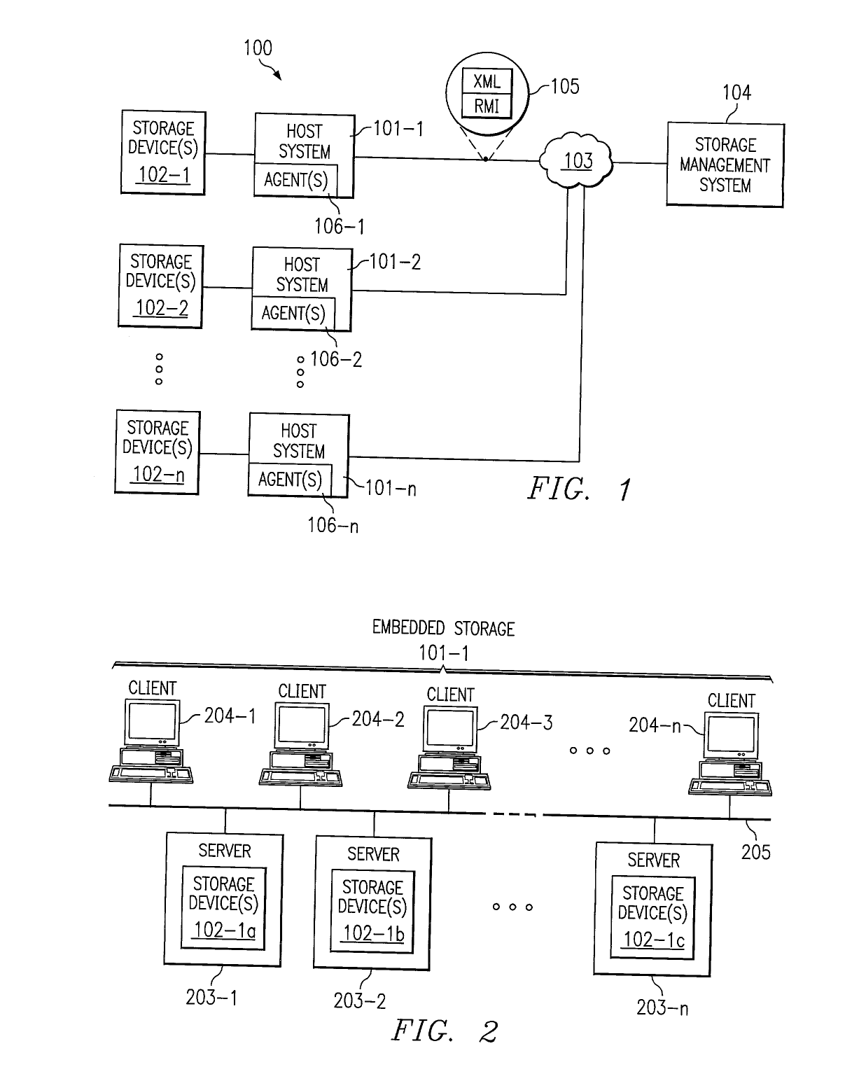

For example, the host system and storage device(s) may be arranged in an embedded storage configuration, wherein the storage device(s) are embedded in some component(s) of the host system. FIG. 2 provides one example of such a configuration. In the embodiment of FIG. 2, host system 101-1 includes one or more client devices, represented in FIG. 2 as clients 204-1, 204-2, 204-3, and 204-n, and one or more server devices, represented in FIG. 2 as servers 203-1, 203-2, and 203-n. The client devices and server devices of FIG. 2 are communicatively coupled to each other by way of connection 205. Connection 205 may be any one of numerous known means for communicatively coupling computers to include data network connections (e.g., a local area network (LAN), metropolitan area network (MAN), or wide area network (WAN) connection), USB (Universal Serial Bus) connections, SCSI connections, fibre channel connections, IDE (Integrated Drive Electronics) connections, etc. As can be seen, in the embedded storage configuration of FIG. 2, storage device(s) 102-1a, 102-1b, and 102-1c, representing storage device(s) 102-1 in FIG. 2, are embedded in servers 203-1, 203-2, and 203-n.

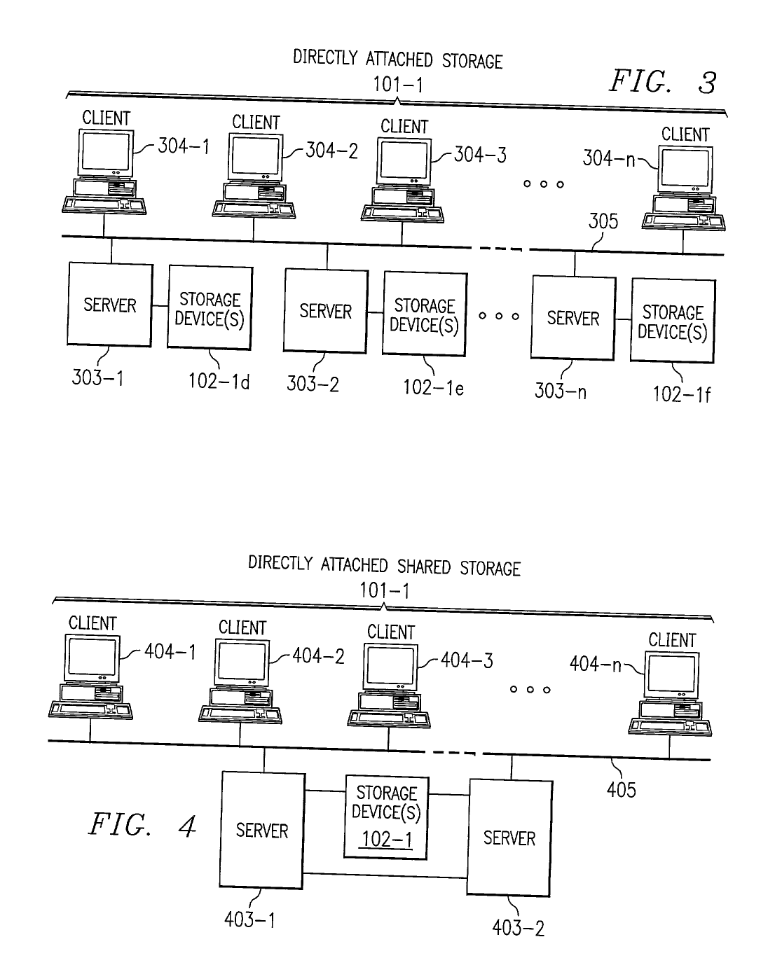

Rather than an embedded storage configuration, the storage device(s) and host system may be arranged in a directly attached storage configuration. FIG. 3 provides one example of such a configuration. In the embodiment of FIG. 3, host system 101-1 includes one or more client devices, represented in FIG. 3 as clients 304-1, 304-2, 304-3, and 304-n, and one or more server devices, represented in FIG. 3 as servers 303 -1, 303-2, and 303-n. The client devices and server devices of FIG. 3 are communicatively coupled to each other by way of connection 305. Similar to connection 205, connection 305 may be any one of numerous known means for communicatively coupling computers to include data network connections (e.g., a LAN, MAN, or WAN connection), USB connections, SCSI connections, fibre channel connections, IDE connections, etc.

In the directly attached storage configuration of FIG. 3, each of storage device(s) 102-1d, 102-1e, and 102-1f (representing storage device(s) 102-1 in FIG. 3) are each directly attached to, rather than embedded in, one of servers 303-1, 303-2, and 303-n. The connection between one of storage device(s) 102-1d, 102-1e, and 102-1f and one of servers 303-1, 303-2, and 303-n may be any one of numerous known means for directly coupling a computer to a storage device to include a USB connection, a serial port, a SCSI interface, an IDE connection, etc.

On the other hand, as an alternative, the storage device(s) and host system may be arranged in a directly attached shared storage environment. FIG. 4 provides one example of such a configuration. In the embodiment of FIG. 4, host system 101-1 includes one or more client devices, represented in FIG. 4 as clients 404-1, 404-2, 404-3, and 404-n, and one or more server devices, represented in FIG. 4 as servers 403-1 and 403-2. The client devices and server devices of FIG. 4 are coupled to each other by way of connection 405. Similar to connection 205, connection 405 may be any one of numerous known means for communicatively coupling computers to include data network connections (e.g., a LAN, MAN, or WAN connection), USB connections, SCSI connections, fibre channel connections, IDE connections, etc.

In the directly attached shared storage configuration of FIG. 4, each of servers 403-1 and 403-2 are directly attached to storage device(s) 102-1. The connection between servers 403-1 and storage device(s) 102-1, as well as the connection between server 403-2 and storage device(s) 102-1, may be any one of numerous known means for directly coupling a computer to a storage device to include a USB connection, a serial port, a SCSI interface, an IDE connection, etc. Furthermore, in the embodiment of FIG. 4, in addition to their connections to storage device(s) 102-1, servers 403-1 and 403-2 are also coupled to each other.

However, rather than the earlier described directly attached configurations, a host system and a storage device(s) may be arranged in a network attached storage configuration. FIG. 5 provides one example of this type of configuration. In the embodiment of FIG. 5, host system 101-1 includes one or more client devices, represented in FIG. 5 as clients 504-1, 504-2, 504-3, and 504-n, and one or more server devices, represented in FIG. 5 as servers 503-1 and 503-2. The client devices and server devices of FIG. 5 are communicatively coupled to each other by way of connection 505. However, in the embodiment of FIG. 5, also communicatively coupled to the clients and servers by way of connection 505 are storage device(s) 102-1g and 102-1h (these devices representing storage device(s) 102-1 in FIG. 5). In the embodiment of FIG. 5, connection 505 represents any one of numerous known data network connections (e.g., a LAN, WAN, or MAN connection).

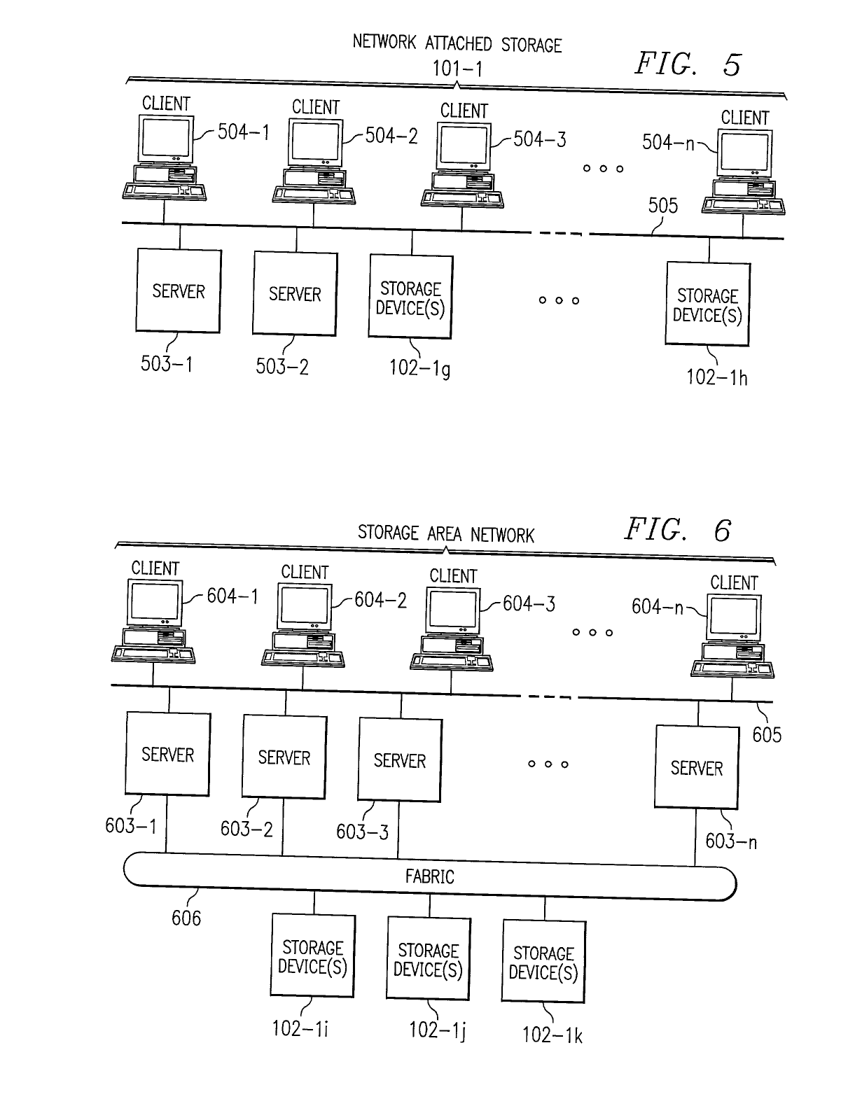

Moreover, rather than a network attached storage configuration, a host system and a storage device(s) may be arranged in a storage area network (SAN) configuration. FIG. 6 provides one example of this type of configuration. In the embodiment of FIG. 6, host system 101-1 includes one or more client devices, represented in FIG. 6 as clients 604-1, 604-2, 604-3, and 604-n, and one or more server devices, represented in FIG. 6 as servers 603-1, 603-2, 603-3, and 603-n. The client devices and server devices of FIG. 6 are coupled to each other by way of connection 605. Similar to connection 205, connection 605 may be any one of numerous known means for communicatively coupling computers to include data network connections (e.g., a LAN, MAN, or WAN connection), USB connections, SCSI connections, fibre channel connections, IDE connections, etc.

However, in the embodiment of FIG. 6, in addition to being communicatively coupled to clients 604-1, 604-2, 604-3, and 604-n, as well as servers 603-1, 603-2, 603-3, and 603-n, are communicatively coupled to storage device(s) 102-1i, 102-1j,and 102-1k via fabric 606. In at least one embodiment, fabric 606 may includes one or more known network connection devices such as switches, hubs, bridges, routers, and/or the like. Storage device(s) 102-1i,102-1j,and 102-1k represent storage device 102-1 in FIG. 6.

In alternative embodiments, rather than being communicatively coupled via fabric 606, clients 604-1, 604-2, 604-3, and 604-n, as well as servers 603-1, 603-2, 603-3, and 603-n, may be communicatively coupled to storage device(s) 102-1i, 102-1j,and 102-1k via a fibre channel arbitrated loop or a fibre channel point to point connection configuration.

It will be appreciated by one of ordinary skill in the art that the configurations shown in FIGS. 2, 3, 4, 5, and 6 are by way of example only, for various other configurations may be employed, to include any combination of the above configurations. Moreover, the host systems depicted in FIGS. 2, 3, 4, and 5 are by way of example only, for as described earlier, a host system may include any number of computers and related devices. Therefore, as an example, in the configuration of FIG. 2, in addition to client devices and server devices, peripheral devices, e.g., a printer(s), may also be included in host system 101-1.

In the embodiment of FIG. 1, in addition to being communicatively coupled to storage devices 102-1, 102-2, and 102-n, as mentioned, host systems 101-1, 101-2, and 101-n may also be communicatively coupled to data network 103. In at least one embodiment, one or more of storage devices 102-1, 102-2, and 102-n are also communicatively coupled to data network 103. Data network 103 may be any one of numerous data networks to include a LAN, a MAN, a WAN, or a larger network. Data network 103 may be implemented utilizing any number of communication mediums and protocols.

In addition to the storage devices and host systems of enterprise environment 100, storage management system 104 may also be communicatively coupled to data network 103. Storage management system 104 is an intelligent storage administration product that monitors and manages the storage-related devices of enterprise environment 100. Storage management system 104 may include storage management software running on one or more designated computer devices.

In operation, in at least one embodiment, storage management system 104 may allow a network administrator, or other personnel, to monitor and manage storage for enterprise environment 100 via a user interface on storage management system 104 or one of host systems 101-1, 101-2, and 101-n. Storage management system 104 may also autonomously perform some or all of these management or monitoring tasks utilizing policy driven criteria. For example, data paths may be reconfigured in the event of a broken communication link. Additionally, data paths may be automatically added or removed to allocate bandwidth to particular applications or users to minimize waiting time or to perform other desired goals.

As part of its task of managing and monitoring the storage devices of enterprise environment 100, oftentimes storage management system 104 retrieves information from host systems 101-1, 101-2, and 101-n (e.g., through the one or more host agents residing on the one or more host systems of enterprise environment 100, such as agent(s) 106-1, 106-2, and 106-n of FIG. 1). In at least one embodiment, the information retrieved is device discovery information. For purposes of this disclosure, the phrases “device discovery” and “device identification” refer to the quantification and qualification of manageable storage-related components in a computing environment (e.g., enterprise environment 100). In at least one embodiment, as part of this quantification and qualification, one or more input/output (I/O) paths are examined and the storage-related device(s) associated with each path, among other things, are determined. These storage-related devices may be physical, logical, and/or virtual storage-related devices.

Moreover, in at least some embodiments, Logical Unit Number (LUN) information is 25 discovered as well. The storage in a storage device may comprise one or more addressable entities referred to as Logical Units. Each Logical Unit may be addressed by a host system(s) using a Logical Unit Number (LUN) associated with the particular Logical Unit. A storage device LUN(s) is defined by an open system protocol designed to coordinate communication or to define logical connection between a host and a plurality of I/O paths associated with various devices. As can be seen, depending upon the number of Logical Units within a storage device, a storage device may have more than one LUN associated therewith. Each host I/O path will point to one storage device LUN. In at least one embodiment, when querying a storage device, using, e.g., SCSI or Fibre channel protocol standards, the LUN is part of the address information required to access the storage device.

In addition to or in lieu of the above, device discovery may also include discovering software components, data and data structures, associations, enterprise processes, enterprise policies, and/or path information (e.g., path status) associated with the storage-related device(s) for a particular input/output (I/O) path.

In at least one embodiment, each of the host agents of enterprise environment 100 (e.g., agent(s) 106-1, 106-2, and 106-n) perform device discovery at least in part, through queries made to storage devices pursuant to SCSI protocols. In addition to SCSI inquiries, storage device (as well as other related) information may be acquired through system files and/or a system registry(ies) (e.g., in a Windows OS environment), Operating System (OS) Kernel Application Programming Interface (API) calls, and/or host bus adapter device driver library APIs (e.g., standard SNIA library provided by host bus adapter vendors). Moreover, device information can also be discovered through bus scanning, which, in at least one embodiment, involves stepping through all of the SCSI or Fibre channel addresses and sending SCSI inquiries to discover any storage devices that reply. Furthermore, in at least some embodiments, in addition to or in lieu of the host agent(s), some portion of the host system(s) of enterprise environment 100 other than the host agent(s) residing on the host system(s) performs device discovery.

Device discovery is normally performed during discovery polling periods. Generally, each host agent (and/or other portion(s) of the host systems) has its own polling periods, one for device discovery and one for device status checks. Generally, the information collected during the polling periods is kept locally at the host system and updated continuously as needed when new information is found during the host device discovery and device status checks. In addition, in at least one embodiment of the present invention, the number of times device discovery is performed, the duration of the polling period, and/or the period of time between each polling period are configurable variables that may be set by an administrator of enterprise environment 100, as well as other individuals.

The information obtained by a host agent (and/or other portion(s) of a host system) during a single discovery polling period may include any and all information useful in the management and monitoring of storage devices, to include device address information. The host agent(s) (and/or other portion(s) of the host system(s)) may also supplement the information obtained from the storage devices with additional information. Examples of the types of information that may be collected during a single discovery period include information relating to the host on which a host agent is running (e.g., name, type, size, description, timestamp of last discovery polling period, host system operating system type and/or version, host model/architecture, serial number, Java Version and related information (if applicable), address information (e.g., host system network IP address), and more); information about the agent itself (e.g., name, type, size, description, version, build, copyright information, discovery polling period, status polling period, and more); device and LUN information (e.g., name, type, size, description, address, vendor ID, product ID, serial number, product revision, topology, host bus adaptor (HBA) name, status, capacity, path status, node world wide name, unique ID, and more); host bus adaptor (HBA) information(e.g., name, type, size, description, address, unique ID, world wide name, manufacturer name, model, serial number, firmware version, driver version topology, port world wide name, node world wide name, fabric name, port max speed, port current speed, number of discovered ports that a particular port can communicate with, HBA index, and more); topology information (e.g., topology relationship between the host system and storage devices); path status information; software information (e.g., application name, vendor, version(s), and patch-level(s), and more); data and data structure information; association target information; policy and process information; and more.

In at least one embodiment, the host agents of enterprise environment 100 (e.g., agent(s) 106-1, agent(s) 106-2, and agent(s) 106-n) provide an Application Programming Interface (API) that may be used by storage management system 104 to communicate with the host agents, to include retrieving the above described information. Moreover, in addition to or as an alternative to the above, one or more of the host agents may include a generic storage device discovery engine from which storage management system 104 may obtain the above-described information.

In one embodiment, after a host agent (and/or other portion(s) of a host system) obtains, and, in some instances, supplements, the requested information for a discovery polling period, the structure(s) of the collected body of information is(are) defined or identified using a markup language or other means for identifying structures in a document. In at least one embodiment, such defining or identification is performed by a host agent(s) and/or other portion(s) of a host system. Documents for purposes of this disclosure mean not only traditional documents, but also the myriad of other data formats, to include vector graphics, mathematical equations, object meta-data, server APIs, and numerous other kinds of structured information. In at least one embodiment, the structure(s) of the collected information are defined with respect to an interface of the host system and/or agent of the host system.

Preferably, the markup language or other means described above provides a facility to define tags, as well as the structural relationships between the tags. Moreover, it also preferred that the above described means for identifying or defining data structures is flexible to interface changes.

One language that meets the above criteria is extensive markup language (XML). One advantage of XML is that it is context specific, as well as flexible enough to allow a variable number of multi-level embedded records of data, all of which are useful in structuring the storage device discovery (to include path status information).

In at least one embodiment of the present invention, storage management system 104 periodically polls each host agent (e.g., hosts 106-1, 106-2, and 106-n) and/or other portion(s) of the host systems of enterprise environment 100 and inquires as to the last time there was a change in discovery data, to include status information (both device and path), for the storage devices, to include host bus adaptors. If the time returned to storage management system 104 is different than the latest time recorded at storage management system 104 for the retrieval of discovery information from that particular host agent and/or other host system components, then, preferably, the discovery data currently available at the host system is provided to storage management system 104 (e.g., by the host agent(s) and/or some other portion(s) of the host system). In at least one embodiment, all of the discovery information available from the host system is provided to storage management system 104 in a bulk transfer (e.g., as concatenated stream of data), rather than a series of small transfers (e.g., a series of transfers wherein each transfer only involves information relating to a particular storage device or one category of information for a particular storage device). Furthermore, in some embodiments, such a transfer of information to storage management system 104 may occur simultaneous with the formatting of the information described above.

Moreover, in at least some embodiments, in addition to responding to the polling of the host agents (and/or other portion(s) of the host systems) by storage management system 104, the host agents (and/or other portions of the host systems), upon discovery of new information of the kind described earlier, will send an event with the newly discovered information to storage management server 104 so as to keep storage managements system 104 up to date as new information is discovered by the host.

In the present invention, the formatted data, as well as the event discussed above, is transported to storage management system 104 using a remote procedure call. In a preferred embodiment, the remote procedure call used to transport the formatted data to storage management system 104 is operating system independent. One example of such an operating system independent remote procedure call is Java's Remote Method Invocation (RMI), which is operable on any operating system that supports Java.

Formatted data unit 105 of FIG. 1 illustrates this transport of discovery data from a host agent of enterprise environment 100, particularly a host agent of agent(s) 106-1, to storage management system 104. As can be seen in the exploded view of data unit 105 provided in FIG. 1, in the embodiment of FIG. 1, the data has been formatted using XML syntax and is being transported via Java RMI.

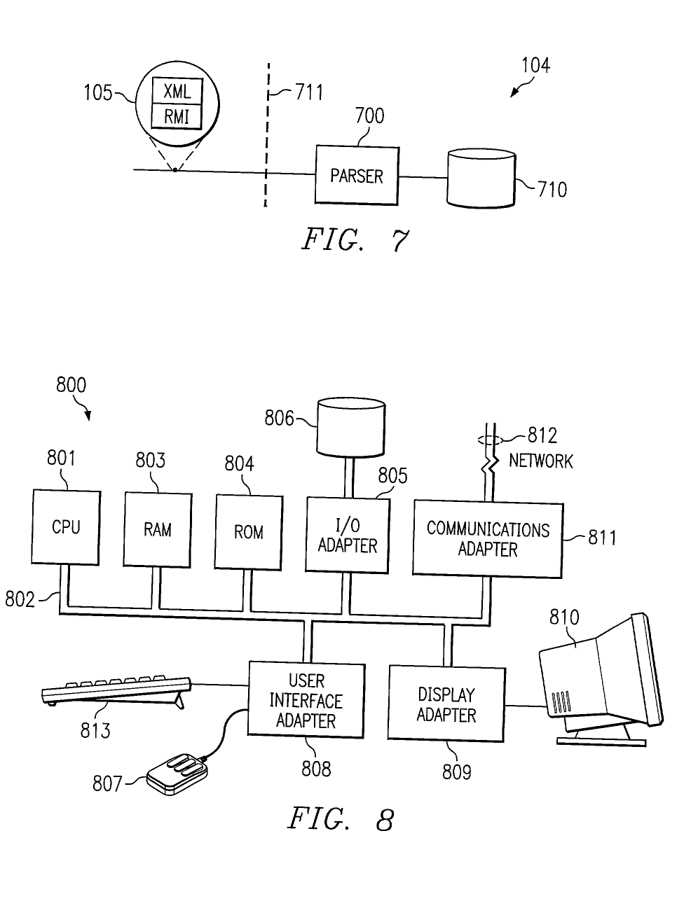

FIG. 7 illustrates an exemplary embodiment of the actions performed on formatted data unit 105 upon its arrival at storage management system 104. Dashed line 711 represents a boundary (be it conceptual or physical) of storage management system 104. In at least one embodiment, after crossing over dashed line 711, formatted data unit 1 05 is divided into components (e.g., tokens) and analyzed by parser 700.

In at least one embodiment, parser 700, among other things, aids in the processing of the discovery information provided by one or more host agents (and/or other portions of the host systems) by dividing the provided data into smaller units. The particular parser employed in storage management system 104 depends upon the means used to format the information collected by the agent(s) (and/or host systems) during a discovery polling period. In embodiments wherein the information was formatting using XML, a standard XML parser may be used to divide the information.

After the information has been parsed, it is then processed and stored by storage management system 104. In at least one embodiment, as part of this procedure, the discovery information is published to the subscribing temporary and/or permanent directories, databases and/or display(s) of storage management system 104 (e.g., database 710). In addition, in at least one embodiment, as part of this processing and storage of the parsed information, the parsed information is inserted into data fields/records of an interface of storage management system 104.

In a preferred embodiment, the interface of storage management system 104 does not require a perfect match with an interface(s) of the host systems (i.e., the interface of storage management system 104 is a forgiving interface). To illustrate, in at least one embodiment of the present invention, if a field of the parsed information includes one or more characters beyond the number of allowable characters for a corresponding field of the interface of the storage management system, rather than abort, the interface of the storage management system will instead be forgiving and accept the extra characters. As another example, in at least one embodiment, if a new field is added to the information provided by the host system which the management server wasn't expecting ,the management server ignores the new field, rather than refusing the provided information. As yet another example, in at least one embodiment, if the information provided by the host system does not include a field the management system was expecting, again, rather than abort, instead the management system inserts a default value in place of the expected field.

In one embodiment, once stored at storage management system 104, the above information is accessible to software of storage management system 104 that reviews and processes the stored host data as part of its task of providing services relating to the management and monitoring of storage resources of enterprise environment 100. For example, utilizing the stored host data, software of storage management system 104 may, among other things, map the storage devices of enterprise environment 100. In at least one embodiment, as part of such mapping, software of storage management system 104 reviews the stored host system data and attempts to match up the storage devices and the host systems.

Preferably, in order to accomplish the above, in addition to reviewing the information provided by the host systems of enterprise environment 100, storage management system 104 itself attempts discovery of the storage devices of environment 100. In at least one embodiment, storage management system 104 performs such discovery through network inquiries (e.g., inquiries and commands over TCP/IP (Transmission Control Protocol/Internet Protocol) via SNMP, HTTP (HyperText Transfer Protocol), FTP (File Transfer Protocol), CIM (Common Information Model), socket connection, etc.) to storage devices, as well as other components of enterprise environment 100, communicatively coupled to data network 103. For example, storage management system 104 may make network inquiries to infrastructure devices, such switches and hubs, that have information useful for mapping the storage-related devices of enterprise environment 100.

The format of the returned discovery information in such an instance typically depends upon the format of the connection between device and storage manage system. For example, for SNMP, the format of the returned data normally follows SNMP standards. Similarly, if the commands, etc. are provided via CIM, the format of the data will generally follow CIM standards. However, for HTTP, FTP, and socket connections, the format of the returned data would normally be customized.

It will be appreciated that in addition to mapping the storage devices of enterprise environment 100, storage management system 104, using the stored host system data and/or information retrieved during discovery performed by management system 104 itself, may provide a plethora of services that have value in the management of storage resources. For example, in at least one embodiment of the present invention, through the above discussed information, storage management system 104 may track the status of the storage-related devices of enterprise environment 100, as well as the status of the paths between the storage devices and the host systems. In addition, storage management system 104 may provide storage capacity information for each storage device of enterprise environment 100 for use in storage capacity management. Storage management system 104 may also provide unique information about each device to facilitate generation of a unique identifier for each of the devices that facilitates the ability to draw multiple connections to the same device instead of duplicate devices. In addition, storage management system 104 may provide an address for a device relative to the host that can be used for issuing commands to and gathering information from the device. Furthermore, storage management system 104 may provide detailed information about a storage device for identification and support of the device (e.g., type of device, manufacture, product revision, type of interconnection, product ID, serial number, etc.).

It will also be appreciated by one of ordinary skill in the art that the configuration of storage management system 104 in FIG. 7 is by way of example only for a storage management system may include other components not depicted in FIG. 7.

Furthermore, in at least one embodiment of the present invention, not only may software of storage management server 104 utilize the stored host data (or other acquired discovery information) to provide services valuable in the management of storage resources, but other subscribers of storage device discovery and path status information may benefit from the stored host data (or other discovery information) as well.

For example, storage device vendors sometimes provide management software for their devices. In certain instances, these device management applications can be integrated into the storage management application(s) of storage management system 104. Such device management software may utilize the stored host data or other stored discovery information in accomplishing their designated tasks. For example, particular device management software may launch an application when the discovered device on the topology map associated with that particular device software is selected. Such device management software may also use the gathered discovery information to determine the behavior of the device associated with the software. In addition, such device management software may use the stored address of the device relative to the host for issuing commands to and gathering additional information from the device to facilitate management of the device.

Other potential beneficiaries of the gathered discovery information include higher level applications. For example, information gathered from the hosts (status information, device information, capacity, etc.) can be passed up from storage management system 104 to higher level management applications like system/enterprise management applications, policy management applications, etc. To demonstrate, the stored host data may indicate the failure of a disk on which key business functions depend. This information can be forwarded to a policy management application, which may show the impact on all impacted business applications and possibly take corrective action.

It will be appreciated that although the above described examples relate to device discovery information and a storage management system, embodiments of the present invention may also be employed in the transfer of other data between a host system(s) and a storage management system or other administration system(s) of an enterprise environment.

Various embodiment of the present invention alleviate the disadvantages present in the prior art for several reasons. First, with the use of an operating system independent remote procedure call (e.g., Java RMI) to transport data between a host system and the storage management system, no new development or recompilation is required to support new operating systems. Another benefit of embodiments of the present invention, particularly embodiments employing Java RMI, is the speed at which such data may be transported.

In addition, by defining the storage device discovery and path status information using a flexible markup language format (e.g., XML), various embodiments of the present invention are flexible to interface changes. Therefore, the different versions of interfaces for the host system and storage management system are much easier to coordinate.

Furthermore, aiding in this flexibility is the forgiving nature of embodiments of the interface of the storage management system. For example, in at least one embodiment of the present invention, the interface of the storage management system ignores any additional, unexpected data, rather than refusing the provided information. Similarly, if additional information is expected by the storage management system but not found in the host data, then default values are assigned by the storage management system.

Other advantages of embodiments of the present invention include the fact that, in at least some embodiments, since the host data is provided in a bulk transfer, rather than a series of transfers, there is minimal impact to network resources. Furthermore, because some of the components of embodiments of the present invention may be found in the off-the-shelf variety (e.g., a standard XML parser), rather than having to be specifically developed for the particular enterprise environment, significant time and development costs are avoided.

In certain embodiments of the present invention, when implemented via executable instructions, various elements of the present invention are in essence the code defining the operations of such various elements. For example, as mentioned earlier, the host agent(s) of enterprise environment 100 may be implemented as an executable program(s) that exists as a running process or service on a host system(s) of enterprise environment 100. The executable instructions or code may be obtained from a readable medium, such as a readable medium of a host system or storage device(s) of enterprise environment 100 (e.g., a hard drive media, optical media, EPROM, EEPROM, tape media, cartridge media, flash memory, ROM, memory stick, and/or the like) or communicated via a data signal from a communication medium (e.g., data network 103). In fact, readable media can include any medium that can store or transfer information.

According to various embodiments, one or more of the host systems and/or storage devices of enterprise environment 100, as well as storage management system 104, may comprise a processor based implementation. For example, FIG. 8 shows computer system 800 which may be included within one or more of the host systems and/or storage devices of enterprise environment 100, as well as storage management system 104. In FIG. 8, one or more central processing unit(s) (CPU(s)) 801 is(are) coupled to system bus 802. CPU(s) 801 may be any general purpose CPU, such as an Intel Pentium® processor. However, the present invention is not restricted by the architecture of CPU(s) 801 as long as CPU(s) 801 supports the inventive operations as described herein. Computer system 800 may include bus 802. Computer system 800 may also include random access memory (RAM) 803, which may be SRAM, DRAM, SDRAM. Computer system 800 may further include ROM 804 for holding user and system data and programs as is well known in the art. For example, an agent(s) of a host system of enterprise environment 100 may be stored in RAM, ROM, and/or executed on CPU(s) 801.

Computer system 800 may also include input/output (I/O) controller card 805, communications adapter card 811, user interface card 808, and display card 809. I/O controller card 805 may connect to storage devices 806 (which may be storage device(s) 102-1, 102-2, and/or 102-n of enterprise environment 100), such as one or more of hard drive, CD drive, floppy disk drive, tape drive, etc., to computer system 800. Communications card 811 may also be adapted to couple computer system 800 to network 812 (e.g., data network 103 of FIG. 1), which may be one or more of telephone network, local (LAN) and/or wide-area (WAN) network, Ethernet network, Fibre Channel network, Internet network, and/or the like. User interface card 808 may also couple user input devices, such as keyboard 813 and pointing device 807, to computer system 800. Display card 809 may be driven by CPU 801 to control the display on display device 810.

What is claimed is:

1. A method for the communication of data between at least one host system and a storage management system, the method comprising:
defining structure for data to be transported from said at least one host system to said storage management system using a markup language; and
transporting said defined data from said at least one host system to said storage management system via a remote procedure call.

2. The method of claim 1, wherein said markup language includes a facility to define tags, as well as structural relationships between tags.

3. The method of claim 2, wherein said markup language is extensive markup language (XML).

4. The method of claim 3, wherein said remote procedure call is an operating system independent remote procedure call.

5. The method of claim 4, wherein said remote procedure call is Java Remote Method Invocation (RMI).

6. The method of claim 5, wherein said defined data is device discovery data.

7. The method of claim 1, wherein said defining is performed by at least one host agent residing on said at least one host system.

8. The method of claim 7, wherein said transporting is facilitated by said at least one host agent.

9. The method of claim 1, wherein said method further includes:
retrieving said data to be transported to said storage management system from at least one storage device embedded in or communicatively coupled to said at least one host system prior to defining the structure of said data to be transported.

10. The method of claim 9, wherein said retrieving is performed by at least one host agent residing on said at least one host system.

11. The method of claim 1, wherein said method further includes:
processing said defined data at said storage management system.

12. The method of claim 11, wherein said processing includes:
parsing said defined data using a markup language.

13. The method of claim 12, wherein said parsing is performed by a standard extensive markup language (XML) parser.

14. The method of claim 11, wherein said processing includes providing said defined data to a flexible interface of said storage management system.

15. The method of claim 14, wherein said interface is operable to accept at least a portion of said defined data corresponding to a data field of said interface that exceeds a size parameter of said corresponding data field.

16. The method of claim 14, wherein said interface is operable to ignore any portion of said defined data that does not correspond to a data field of said interface.

17. The method of claim 14, wherein said interface is operable to insert at least one default value into a data field of said interface when information relating to said field is not provided in said defined data.

18. The method of claim 1, wherein said transporting occurs in response to a request from said storage management system, said request being made after said storage management system determines a change in device information has occurred since a prior transmission of data to said storage management system.

19. A system for the monitoring and management of storage-related devices of an enterprise environment, said system comprising:
means for obtaining discovery information from at least one storage-related device of said enterprise environment;
means for defining structure of said obtained information using a markup language; and
means for transporting said obtained information from said defining means for further processing.

20. The system of claim 19, wherein said markup language is extensive markup language (XML).

21. The system of claim 19, wherein said means for transporting includes Java Remote Method Invocation (RMI).

22. The system of claim 18, wherein said further processing includes a processing means flexible to differences between an interface of said defining means and an interface of said processing means.

23. A system for the monitoring and management of storage-related devices of an enterprise environment, said system comprising:
at least one host system;
at least one host agent process, wherein each of said at least one host agent process resides on a respective host system of said at least one host system; and
a storage management system, wherein said storage management system is communicatively coupled to said at least one host system;
wherein at least one of said at least one host agent process is operable to define device discovery information in a markup language format and transport said formatted discovery information to said storage management system via a remote procedure call.

24. The system of claim 23, wherein said markup language format is an extensive markup language (XML) format.

25. The system of 23, wherein said remote procedure call is Java Remote Method Invocation (RMI).
